(19) United States
(12) Patent Application Publication
(10) Pub. No.: US 2006/0158421 A1
(43) Pub. Date: Jul. 20, 2006

(54) Driver circuit of display device and method of driving the same

(75) Inventor: Akira Masuko, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/305,199

(22) Filed: Dec. 19, 2005

(30) Foreign Application Priority Data
Dec. 20, 2004 (JP) 2004-367461

(51) Int. Cl. G09G 3/36

(52) U.S. Cl. 345/100

(57) ABSTRACT

A display device is provided with pixels, data lines to supply the pixels with video signals, a shift register circuit to select the pixels, a power source to generate a voltage, a detection circuit to detect a starting-up portion of the voltage, and a driver circuit. The driver circuit includes output terminals connected to the pixels and output buffer circuits. The output buffer circuits are connected to a reference potential, make the output terminals have high impedance states in response to the starting-up portion of the voltage detected by the detection circuit and subsequently supply a non-driving voltage and then a driving voltage to turn off and on the pixels selected by the shift register circuit, respectively.

### CROSS-REFERENCE OF RELATED APPLICATIONS

This application is based upon and claims the benefit of priority from the prior Japanese Patent Application No. 2004-367461, filed on Dec. 20, 2004, the entire contents of which are incorporated herein by reference.

### FIELD OF THE INVENTION

This invention generally relates to a display device and, more particularly, to a driver circuit of a display device and a method of driving the same.

### BACKGROUND OF THE INVENTION

Flat panel display (“FPD”) devices include liquid crystal display (“LCD”) devices, field emission display (“FED”) devices, electro-luminescent (“EL”) display devices and plasma display panel (“PDP”) devices. Especially, active matrix type LCD devices and organic EL devices with thin-film transistor (“TFT”) circuits have been widely used in many applications.

An active matrix type LCD device is provided with a signal control circuit, a liquid crystal driver circuit and a display panel. The liquid crystal driver circuit is composed of a vertical driver which drives gate electrodes of the TFT devices and is called a gate driver circuit and a horizontal driver which drives source electrodes of the TFT devices and is called a source driver circuit. The gate driver circuit has a function to output scanning signals to scanning lines while the source driver circuit has a function to output display data signals to data lines. The source driver circuit is connected to the source electrodes of the TFT devices through data lines for the display panel of the active matrix type LCD device while the gate driver circuit is connected to gate electrodes of the TFT devices through the scanning lines for the display panel (disclosed in Patent Publication 2000-134053, for instance).

LCD devices and EL display devices used in personal computers and cellular phones increase the number of half tone levels to display a variety of colors so that the number of lines increases to output signals from gate and source driver circuits to the LCD devices and EL display devices. Source lines are required rapidly to increase in number up to 384 while gate lines are also required to increase in number up to 256, for example. When electric power sources such as DC-DC converters turn on, each driving terminal of the scanning lines (the gate of each TFT device) is supplied with an “Off” level voltage VGL or an “On” level voltage VGH of the DC-DC converter or supplied with an “Off” level voltage VGL of a power-on-reset circuit because internal states of LSI devices provided in the gate driver circuit have not stabilized yet. In other words, since a load of a display panel is supplied with electric charges through all driving terminals of the scanning lines, excessively large electric currents flow instantaneously from the DC-DC converter to scanning lines through the gate driver circuit

As a result, circuits including such electric power sources must sustain heavy loads and may shut down. Further, wiring components may be fused out because such excessively large electric currents flow through the wiring components. In order to prevent such possible defects, wiring components can be prepared to increase in diameters or electric power sources can be provided with large electric current supply capacities. Those counter measures, however, result in expensive production costs of wiring components and electric power sources.

### SUMMARY OF THE INVENTION

The present invention provides a driver circuit of a display device. The display device includes pixels, data lines to supply the pixels with video signals, a shift register circuit to select the pixels and a power source to generate a voltage. The driver circuit includes a detection circuit to detect a starting-up portion of the voltage and an output circuit provided with output terminals connected to the pixels and output buffer circuits to make the output terminals have high impedance states in response to the starting-up portion of the voltage detected by the detection circuit and subsequently supply a non-driving voltage and then a driving voltage to turn off and on the pixels selected by the shift register circuit, respectively.

The present invention also provides other driver circuits of a display device. The display device includes pixels to display images, data lines to supply the pixels with video signals, a shift register circuit to select the pixels and a power source to generate voltages. The other driver circuits include a detection circuit to detect a starting-up portion of the voltages and a output circuit provided with output terminals connected to the pixels and output buffer circuits to sequentially carry out operations that supply a reference potential to the pixels, make the output terminals have high impedance states and supply a non-driving and a driving voltage to turn off and on the pixels selected by the shift register circuit, respectively, when the starting-up portion of the voltages is detected by the detection circuit.

The present invention further provides a method of driving a display device which includes pixels, data lines to supply the pixels with video signals, a shift register circuit to select the pixels, a power source to generate a voltage, a detection circuit to detect a starting-up portion of the voltage and an output circuit provided with output terminals connected to the pixels and output buffer circuits. The method makes the output terminals have high impedance states in response to the starting-up portion of the voltage detected by the detection circuit and subsequently supply a non-driving voltage and then a driving voltage to turn off and on the pixels selected by the shift register circuit, respectively.

The present invention yet further provides a method of driving a display device which includes pixels to display images, data lines to supply the pixels with video signals, a shift register circuit to select the pixels, a power source to generate voltages, a detection circuit to detect a starting-up portion of the voltages and a output circuit provided with output terminals connected to the pixels and output buffer circuits to sequentially carry out operations that supply a reference potential to the pixels, make the output terminals have high impedance states and supply a non-driving and a driving voltage to turn off and on the pixels selected by the shift register circuit, respectively, when the starting-up portion of the voltages is detected by the detection circuit.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a block diagram of an LCD device in accordance with a first embodiment of the present invention;

FIG. 2 is a block diagram of a gate driver circuit in accordance with the first embodiment of the present invention;

FIG. 3 is a circuit diagram of an output buffer circuit in accordance with the first embodiment of the present invention;

FIG. 4 is a circuit diagram of a switching circuit in accordance with the first embodiment of the present invention;

FIG. 5 is a table indicating relationships between signal levels input to the output buffer circuit and those output to an output terminal in accordance with the first embodiment of the present invention;

FIGS. 6A-6E are timing charts of the LCD device in accordance with the first embodiment of the present invention;

FIG. 7 is a circuit diagram of an output section in accordance with a second embodiment of the present invention;

FIG. 8 is a table indicating relationships between signal levels input to a signal level control section and those output from an output terminal in accordance with the second embodiment of the present invention; and

FIGS. 9A-9E are timing charts of an LCD device in accordance with the second embodiment of the present invention.

### DETAILED DESCRIPTION OF THE INVENTION

Embodiments of the present invention will be explained below with reference to the attached drawings. It should be noted that the present invention is not limited to the embodiments but covers their equivalents. Throughout the attached drawings, similar or same reference numerals and marks show similar, equivalent or same components. The drawings, however, are shown schematically for the purpose of explanation so that their components are not necessarily the same in shape or dimension as actual ones. In other words, concrete shapes or dimensions of the components should be considered as described in these specifications, not in view of the ones shown in the drawings. Further, some components shown in the drawings may be different in dimension or ratio from each other.

### First Embodiment

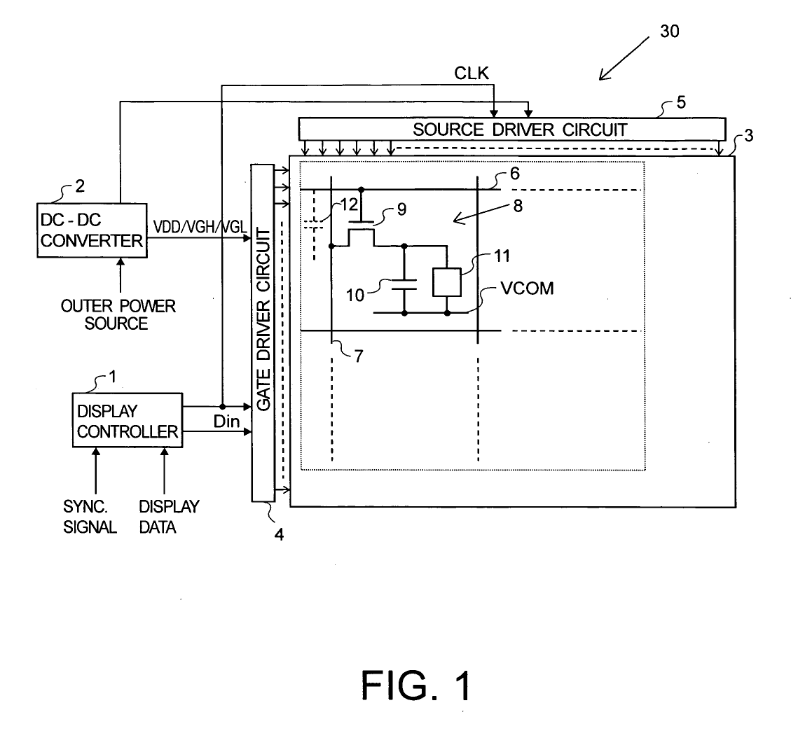

A display device of a first embodiment in accordance with the present invention is described with reference to the drawings. FIG. 1 is a block diagram of an active matrix type LCD device as such a flat panel display device. A gate driver circuit as a vertical driver circuit is set to a high impedance state when the LCD device in the present embodiment starts up. As shown in FIG. 1, LCD device 30 is provided with display controller 1, DC-DC converter 2, display panel 3, gate driver circuit 4 and source driver circuit 5. LCD device 30 is used for a display device of a personal computer, for instance.

Display controller 1 receives synchronization signals such as a clock pulse, etc. and display data of red (R), green (G) and blue (B) and outputs control data for processing image data in the form of parallel data to source driver circuit 5 to carry out the execution of arithmetic operations for LCD device 30. Here, input signal “Din” is control data for processing image data and the like provided to gate driver circuit 4. DC-DC converter 2 functions as a high potential power source to supply voltage VDD for logic circuits and high and low potential power sources to supply voltages VGH and VGL, respectively. DC-DC converter is supplied with a direct current voltage from an outer power source such as a battery and converts the same into high voltage VDD, and high and low voltages VGH and VGL. Voltages VDD, VGH and VGL are provided to gate driver circuit 4. High and low voltages VGH and VGL are used to turn “On” and “Off” of TFT devices 9 in pixels 8 (FIG. 1) so that they are called driving and non-driving voltages, respectively.

Gate driver circuit 4 is supplied with the voltages VDD, VGH and VGL from DC-DC converter 2 and provides such voltages to “m” scanning lines 6, (m=256, for example), in response to input signal Din. Source driver circuit 5 is also supplied with voltages from DC-DC converter 2 and provides data signals to “n” data lines 7, (n=384, for example), to display images.

Thus, display panel 3 is arranged in a (m×n) matrix form, so that display panel 3 is provided with “m” scanning lines 6, “n” data lines and (m×n) pixels 8 surrounded by scanning lines 6 and data lines 7. Each pixel 8 includes TFT device 9, the gate electrode of which is connected to scanning line 6 and the source electrode of which is connected to data line 7, holding capacitor 10 connected between the drain electrode of TFT device 9 and common voltage VCOM and pixel electrode 11 of an LC cell also connected in parallel with holding capacitor 10.

Total capacitor 12 in pixels 8 connected in parallel with one scanning line 6 define a capacitive load of such scanning line 6. In the case of display panel 3 used for a personal computer, such a capacitive load of scanning line 6 is relatively large in value, e.g., 300 PF so that an electric current of 10 mA supplied from DC-DC converter 2 is required for the pre-charge of total capacitor 12. As a result, since the number of scanning lines is 256, the total sum of electric currents “I” supplied to all scanning lines 6 is as follows:
I=10×256 mA=2.56 A
Thus, such a fairly large electric current is required in total for the pre-charge of scanning lines 6 at a time.

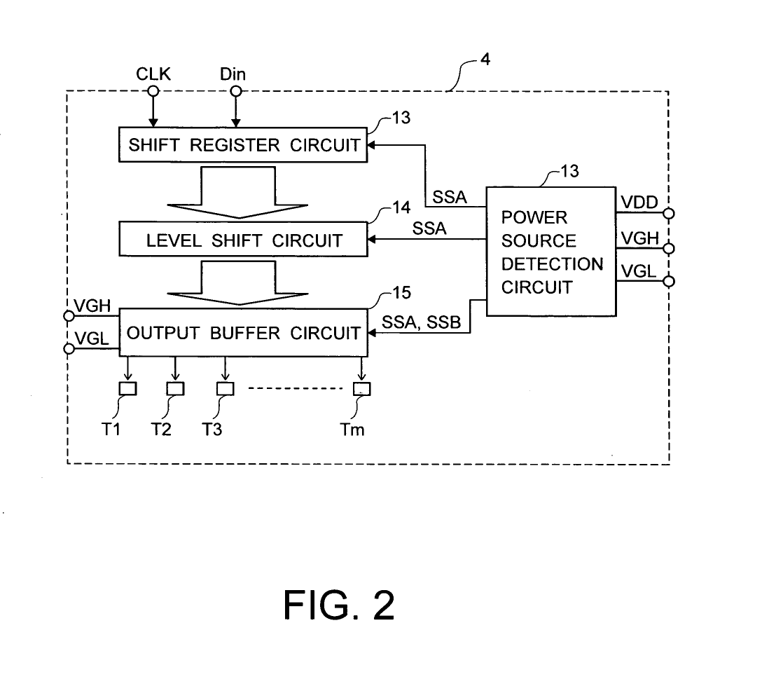

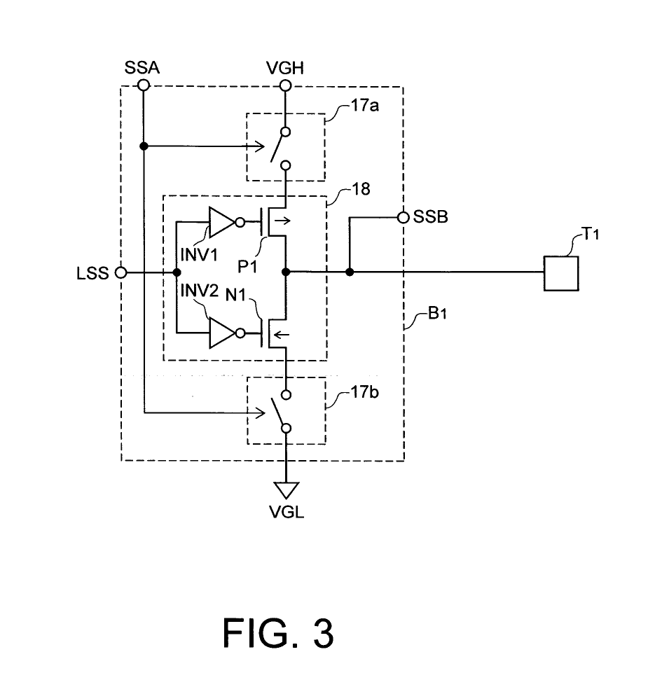

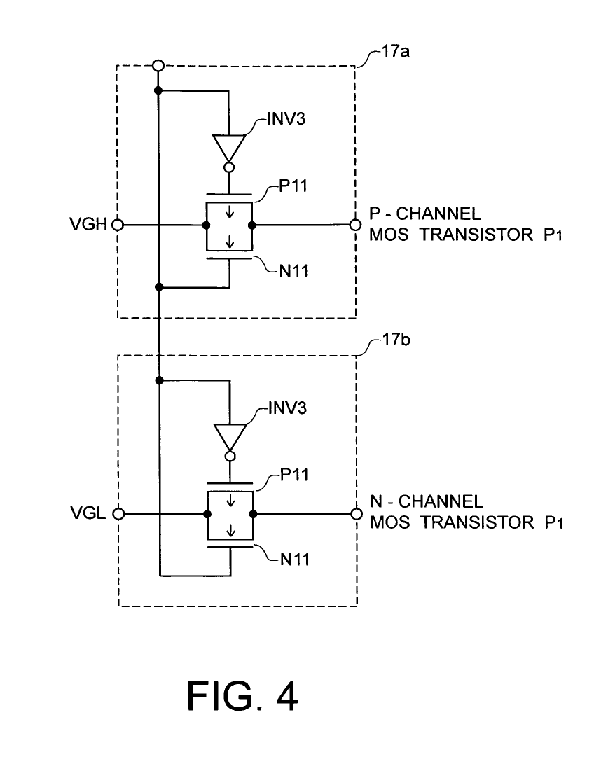

Next, gate driver circuit 4 will be explained with reference to FIGS. 2-4. FIGS. 2 and 3 are block and circuit diagrams, respectively, of gate driver circuit 4 and output buffer circuit 15 while FIG. 4 is a circuit diagram of a switching circuit shown in FIG. 3.

As shown in FIG. 2, gate driver circuit 4 is provided with shift register circuit 13, level shift circuit 14, output buffer circuit 15, power source detection circuit 16 and output terminals T1, T2, . . . , and Tm.

Shift register circuit 13 is supplied with input signal “Din” from display controller 1 and clock signal “CLK” required for the operation of shift register circuit as a reference signal, and provides a driving signal to each scanning line 6 in display panel 3. Level shift circuit 14 is provided between shift register circuit 13 and output buffer circuit 15. Level shift circuit 14 changes a level of an output signal (e.g., a low voltage ranging from 1.5V to 3.0V) supplied from shift register circuit 13 to a relatively high voltage (e.g., a voltage ranging from 10V to several tens of V).

Output buffer circuit 15 is provided between level shift circuit 14 and output terminals T1, T2, . . . , and Tm. Output buffer circuit 15 is supplied with high and low voltages VGH and VGL and provides operation voltages to output terminals T1, T2, . . . , and Tm corresponding to scanning lines 6 in response to the output signal of level shift circuit 14 to display images on display panel 3.

Power source detection circuit 16 is supplied with relatively high voltage VDD for the logic circuits, high voltage VGH and low voltage VGL. Power source detection circuit 16 detect a staring-up portion of voltages VDD, VGH and VGL and generates output signal SSA indicative of the starting-up portion of the voltages and output signal SSB indicative of a reference potential GND, e.g., 0V. Output signal SSA is supplied to control shift register circuit 13 and level shift circuit 14 while output signal SSB is used for output terminals T1, T2, . . . , and Tm connected to output buffer circuit 15.

Output buffer circuit 15 is connected to output terminals T1, T2, . . . , and Tm as shown in FIG. 2. Output buffer circuit 15 includes output control circuits B1, B2, . . . , and Bm corresponding to output terminals T1, T2, . . . , and Tm, respectively. Only output control circuit B1 corresponding to output terminal T1, however, is shown in FIG. 3 as a representative one of output control circuits B1, B2, . . . , and Bm.

In output control circuit B1, output signal SSB supplied from power source detection circuit 16 makes input signal level of output terminal T1 ground potential GND (e.g., 0 V) when LCD device 30 starts up.

Switching circuit 17a supplies high voltage VGH to output circuit 18, receives output signal SSA of power source detection circuit 16 and turns on or off in response to output signal SSA. Likewise, switching circuit 17b supplies low voltage to output circuit 18, receives output signal SSA of power source detection circuit 16 and turns on or off in response to output signal SSA.

Output circuit 18 is provided with P-channel MOS transistor P1, N-channel MOS transistor N1, and inverters INV 1 and INV 2.

Inverter INV 1 receives output signal LSS of level shift circuit 14 (FIG. 2) and supplies its inverted output signal to N-channel MOS transistor N1. Here, output signal LSS corresponds to an output signal of the shift register 13. If such an output signal of the shift register 13, however, is sufficient in level, the same may be used as output signal LSS. The source electrode of P-channel MOS transistor P1 is connected to switching circuit 17a while the drain electrode of P-channel MOS transistor P1 is connected to the drain electrode of N-channel MOS transistor N1. The source electrode of N-channel MOS transistor N1 is connected to switching circuit 17b.

Output terminal T1 is supplied with an output signal of the drain electrodes of N-channel MOS transistor N1 and P-channel MOS transistor P1. Here, a MOS transistor is also called a metal oxide field effect transistor (MOSFET).

As shown in FIG. 4, each of switching circuits 17a and 17b is provided with P-channel MOS transistor P11, N-channel MOS transistor N11 and inverter INV3 to configure a transfer gate.

Output signal SSA of power source detection circuit 16 is supplied to the gate electrode of N-channel MOS transistor N11, and the gate electrode of P-channel MOS transistor P11 through inverter INV3. The source electrodes of N-channel MOS transistor N11 and P-channel MOS transistor P11 of switching transistor 17a are connected to high potential power source VGH. The drain electrodes of N-channel MOS transistor N11 and P-channel MOS transistor P11 are connected to the source electrode of P-channel MOS transistor P1 of output circuit 18 (FIG. 3).

However, the source electrodes of N-channel MOS transistor N11 and P-channel MOS transistor P11 of switching circuit 17b are connected to low potential power source VGL and the drain electrodes of N-channel MOS transistor N11 and P-channel MOS transistor P11 are connected to the source electrode of N-channel MOS transistor N1 of output circuit 18 (FIG. 3).

When output signal SSA of power source detection circuit 16 is “Low” in level, switching circuits 17a and 17b turn off. When output signal SSA of power source detection circuit 16 is “High” in level, switching circuits 17a and 17b turn on so that a high voltage VGH or low voltage VGL is provided to output circuit 18.

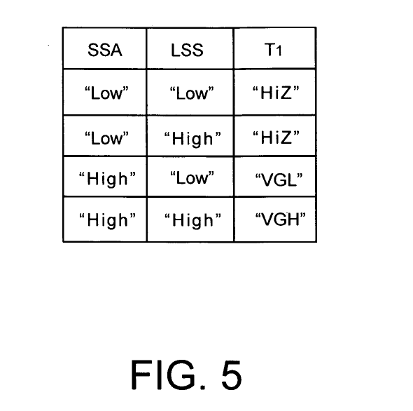

Next, with reference to FIG. 5, a relationship between input and output signal levels of output buffer circuit 15 will be described. FIG. 5 is a table of input and output signal levels and an impedance state of output buffer circuit 15. As shown in FIG. 5, when both output signal SSA of power source detection circuit 16 and output signal LLS of level shift circuit 14 are “Low” in level, switching circuits 17a and 17b turn off so that either P-channel MOS transistor P1 or N-channel MOS transistor N1 is not supplied with any voltage and output terminal T1 becomes high impedance state “HiZ”

Next, when output signal SSA of power source detection circuit 16 is “Low” in level and output signal LLS of level shift circuit 14 is “High” in level, both switching circuits 17a and 17b turn off so that either P-channel MOS transistor P1 or N-channel MOS transistor N1 is not supplied with any voltage and so that output terminal T1 becomes high impedance state “HiZ”.

Since output terminal T1 is in a high impedance state “HiZ” regardless of output signal LSS of level shift circuit 14 whenever output signal SSA of power source detection circuit 16 is “Low” in level, output buffer circuit 15 functions as a first control means for making output terminal T1 high impedance state “HiZ”.

Further, when output signal SSA of power source detection circuit 16 is “High” in level while output signal LLS from level shift circuit 14 is “Low” in level, P-channel MOS transistor turns off but N-channel MOS transistor turns on so that output terminal T1 is supplied with low voltage VGL.

Finally, when output signal SSA of power source detection circuit 16 is “High” in level and output signal LLS from level shift circuit 14 is “High” in level, P-channel MOS transistor turns on but N-channel MOS transistor turns off so that output terminal T1 is provided with high voltage VGH.

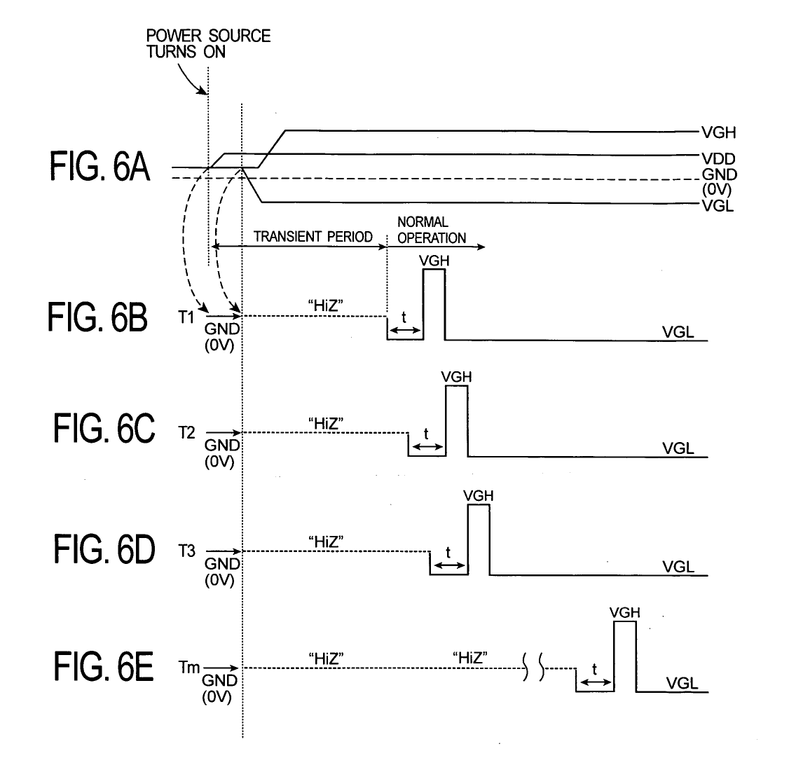

With further reference to FIGS. 6A-6E, operations of LCD device 30 will be described. FIGS. 6A-6E are timing charts to show the operations of LCD device 30.

FIG. 6A shows voltages VGH, VDD, and VGL generated by DC-DC converter 2 (FIG. 1). DC-DC converter 2 converts a voltage of 3V, for instance, from the outer power source such as a battery to voltage VDD of 5V, for instance, supplied to the logic circuits provided in gate driver circuit 4. DC-DC converter 2 also generates high voltage VGH and negative low voltage VGL supplied to gate driver circuit 4, source driver circuit 5 and LCD panel 3. Voltage VGH rises up after voltage VGL starts up as shown in FIG. 6A but voltage VGL may start up after voltage VGH rises up.

Next, when DC-DC converter 2 generates voltage VDD for the logic circuits, output control circuits B1, B2, . . . , and Bm of output buffer circuit 15 provide ground potential GND (0V) to output terminals T1 throgh Tm in response to output signal SSB of power source detection circuit 16, respectively. Thus, all output terminals T1, T2, . . . , and Tm become ground potential GND (0V).

In other words, if other potentials than ground potential GND are supplied to the output terminals T1, T2, . . . , and Tm at the time when the power sources for LCD device 30 are turned on, all loads 12 for scanning lines 6 are pre-charged and excessive electric currents flow through DC-DC converter 2. Since, however, output terminals T1, T2, . . . , and Tm are all provided with ground potential GND, such excessive electric currents are prevented from flowing through DC-DC converter 2.

Further, when DC-DC converter 2 generates voltage VGL, either switching circuit 17a or 17b does not turn on because output signal SSA of power source detection circuit 16 is “Low” in level. As a result, output control circuits B1, B2, . . . , and Bm of output buffer circuit 15 stop operation so that output terminals T1, T2, . . . , and Tm become high impedance state “HiZ”. Output signal SSB of power source detection circuit 16 is not supplied to output buffer circuit 15 after DC-DC converter 2 generates negative low voltage VGL.

Switching circuits 17a and 17b then turn on when “High” level output signal SSA of power source detection circuit 16 is supplied to switching circuits 17a and 17b so that high and low voltages VGH and VGL are supplied to output circuit 18 of output control circuit B1 through switching circuits 17a and 17b, respectively. When, however, output signal LSS of level shift circuits 14 is “Low” in level, N-channel MOS transistor N1 turns on and output circuit 18 provides voltage VGL. Thus, load 12 of scanning line 6 connected to output terminal T1 is pre-charged so that the electric current supplied to DC-DC converter 2 is equal to the one provided for one terminal, i.e., 10 mA. Here, voltage VGL corresponds to the non-driving voltage which does not turn on TFT device 9 of pixel 8.

Output signal LSS of level shift circuits 14 is “High” in level after a pre-charge period of time “t” of voltage VGL, P-channel MOS transistor P1 turns on and output circuit 18 provides voltage VGH as shown in FIG. 6B. High voltage VGH turns on TFT device 9 of pixels 8. Thus, high voltage VGH is provided to scanning line 6 through output terminal T1 thereby turning on TFT device 9 of pixel 8. As a result, a video signal is transmitted to pixel 8 from data line 7 so that pixel 8 displays images. After a display period, output terminal T1 is provided with voltage VGL again as shown in 6B as a result of the operation of output control circuit B1.

As described above, a second control device to pre-charge load 12 of scanning line 6 with voltage VGL includes switching circuits 17a and 17b that turn on in response to “High” level output signal SSA of power source detection circuit 16 and “Low” level output signal LSS of level shift circuit 14.

Subsequently, as shown in FIGS. 6C-6E, the same operation of each of output terminals T2, . . . , and Tm as output terminal T1 is sequentially carried out by shifting its operation. In other words, each of output terminals T2, . . . , and Tm becomes sequentially high impedance states “HiZ” and are then supplied with negative low voltage VGL, high voltage VGH after the pre-charge period of time “t” of low voltage VGL, and low voltage VGL again as set forth above in the case of the operation of output terminal T1.

As described above, LCD device 30 supplied with voltages VDD, VGH and VGL in the embodiment includes power source detection circuit 16 to generate the control signals of output buffer circuit 15 when voltage VDD, VGH, or VGL changes. Output buffer circuit 15 is provided with output control circuits B1, B2, . . . , and Bm, each of which includes output circuit 18 and switching circuits 17a and 17b. Each output circuit Bi, (1≦i≦m), is supplied with reference potential GND and set to high impedance state “HZ” in response to “Low” level output signal SSA of power source detection circuit 16. Output control circuit Bi, (1≦i≦m), on the other hand, generates the “Low” level signal of voltage VGL shifted by a predetermined period of time “t” with respect to the next one.

Thus, since each output terminal Ti, (1≦i≦m), is supplied with the electric current from DC-DC converter 2 after the same is made high impedance state “HiZ, load 12 of scanning line 6 connected to each output terminal Ti, (1≦i≦m), is individually sequentially pre-charged so that excessive electric current is prevented from flowing through DC-DC converter 2.

Thus, such an individual pre-charge structure of a scanning line results in a more eased load imposed on DC-DC converter 2 and the suppression of melting of wiring components provided in LCD device 30 and a shutdown of circuits also provided therein. Further, it is not necessary to provide large size wirings to avoid melting or a power source is not required for a high electric current supply capability so that the production cost of a power source is reduced.

According to the present embodiment, after each output terminal is supplied with ground potential GND and set to high impedance state “HiZ”, its corresponding scanning line load is sequentially pre-charged with low non-driving voltage VGL. The pre-charge of scanning line loads may be carried out through a plurality of corresponding output terminals that are set to high impedance states or corresponding output terminals with high impedance states. As substitutes for switching circuit 17a provided between high voltage VGH and output circuit 18 and switching circuit 17b connected between the low voltage source and output circuit 18, a switching circuit may be connected between output circuit 18 and output terminal T1. Switching circuits may be provided between level shift circuit 14 and each output circuit 18. Further, switching circuits may be each provided between shift register circuit 13 and level shift circuit 14. Switching circuits 17a and 17b are transfer gate structures but may be composed of P-channel or N-channel MOS transistors. In addition, MOS transistors in this embodiment may be substituted for MISFETs (Metal Insulator Semiconductor Field Effect Transistors)

### Second Embodiment

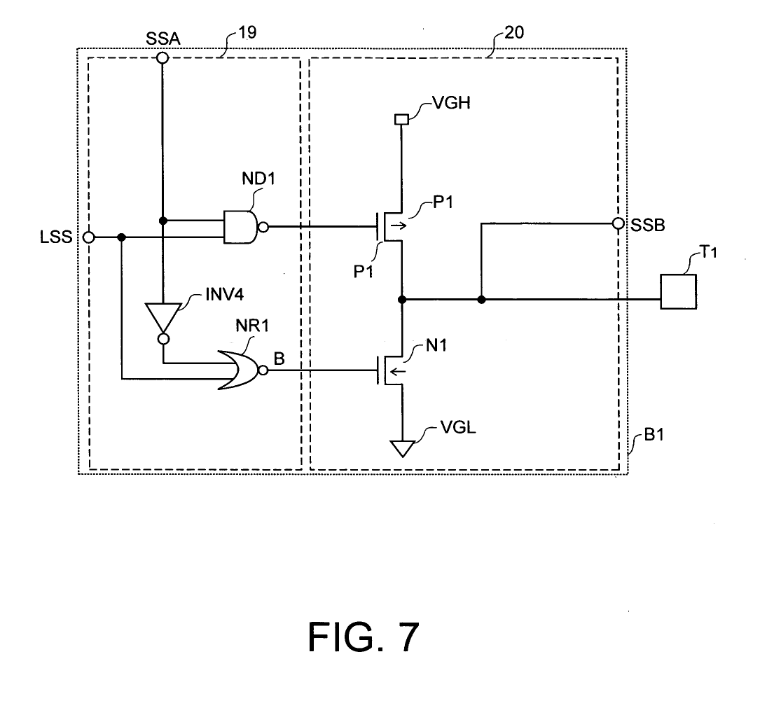

Next, a driver circuit of a second embodiment will be described with reference to the attached drawings. FIG. 7 is a circuit diagram of an output control circuit of output buffer circuit 15 of gate driver circuit 4 (FIG. 1). Output buffer circuit 15 shown in FIG. 7 is different in structure from that of the first embodiment. In the second embodiment, however, scanning line loads are pre-charged at random after an output terminal is set to a high impedance state.

Same reference numeral or marks designate the same or similar components as in the first embodiment so that detailed explanations thereof are omitted but different components will be set forth below.

Output buffer circuit 15 is provided with output control circuits B1, B2, . . . , and Bm but only output control circuit B1 is shown in FIG. 7 as a representative one. Output control circuit B1 includes signal level control circuit 19 and output selection circuit 20.

Output control circuits B1, B2, . . . , and Bm are connected to output terminals T1, T2, . . . , and Tm, respectively. Here, shift register circuit 13 (FIG. 2) is configured to supply output signals to output control circuit Bi, (1≦i≦m), at random, so that output terminal Ti, (1≦i≦m), is designated at random. In this particular embodiment, shift register circuit 13 is assumed to supply output signals to output terminals Ti, Tj, Tk, . . . , and Tm for the purpose of description. Similarly, two output control circuit Bi and Bj, (1≦i, j≦m, i≠j), or more can be supplied with output signals from shift register circuit 13, so that output terminal Ti and Tj, (1≦i, j≦m, i≠j), or more are designated.

Signal level control circuit 19 is provided with inverter INV4, two-input NAND gate ND1 and two-input NOR gate NR1. NAND gate ND1 is supplied with output signal SSA of power source detection circuit 16 and output signal LSS of level shift circuit 14 and carries out a NAND operation to supply output signal “A”. NOR gate NR1 is supplied with output signal LSS of level shift circuit 14 and an output signal of inverter INV4 inverting output signal SSA of power source detection circuit 16 and carries out a NOR operation to supply output signal “B”.

Output selection circuit 20 comprises P-channel MOS transistor P1 and N-channel MOS transistor N1. The source and gate electrodes of P-channel MOS transistor P1 are provided with high voltage VGH and output signal “A” of NAND gate ND1, respectively. The drain electrode of P-channel MOS transistor P1 is connected to that of N-channel MOS transistor N1. The gate electrode of N-channel MOS transistor N1 is connected to NOR gate NR1. The source electrode of N-channel MOS transistor N1 is supplied with low voltage source VGL. P-channel and N-channel MOS transistors P1 and N1 are supplied with outputs from NAND gate ND1 and NOR gate NR1, respectively, and supplies outputs from the drain electrodes of P-channel and N-channel MOS transistors P1 and N1 to output terminal T1.

Output signal SSB of power source detection circuit 16 is also supplied to the drain electrodes of P-channel and N-channel MOS transistors P1 and N1 and output terminal T1. Output signal SSB of power source detection circuit 16 makes output terminal T1 the ground level GND (0V) for a predetermined period of time after the time when the power source of LCD device 30 turns on.

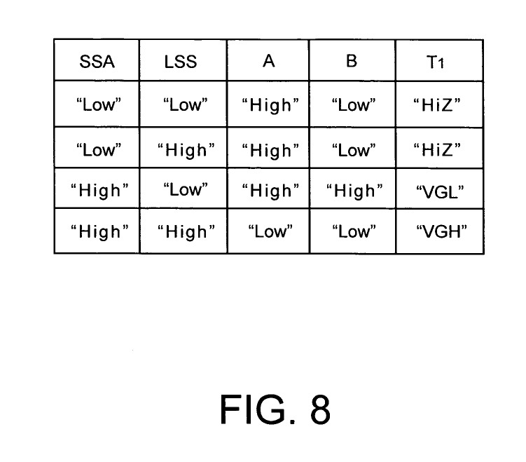

Next, referring now to FIG. 8, relationships between input and output signal levels of output control circuit B1 will be described. FIG. 8 shows input signal levels supplied to signal level control circuit 19, output signals supplied from output selection circuit 20 and impedance states of output terminal T1.

As shown in FIG. 8, when output signal SSA of power source detection circuit 16 and output signal LSS of level shift circuit 14 are “Low” in level, output “A” of NAND gate ND1 is “High” in level but output “B” of NOR gate NR1 is “Low” in level. As a result, both P-channel MOS transistor P1 and N-channel MOS transistor N1 turn off so that output terminal Ti becomes high impedance state “HiZ”.

When output signal SSA of power source detection circuit 16 is “Low” in level and output signal LSS of level shift circuit 14 is “High” in level, that of output signal “A” of NAND gate ND1 is “High” in level but output signal “B” of NOR gate NR1 is “Low” in level. As a result, both P-channel MOS transistor P1 and N-channel MOS transistor N1 turn off so that output terminal T1 becomes high impedance state “HiZ”.

In short, whenever output signal SSA of power source detection circuit 16 is “Low” in level regardless of output signal LSS of level shift circuit 14, output terminal T1 becomes high impedance states “HiZ”. Thus, output signal SSA of power source detection circuit 16 are “Low” in level, i.e., output signal “A” or “B” of signal level control circuit 19 is “Low” in level, output terminal T1 becomes high impedance state “HiZ”.

Subsequently, when output signal SSA of power source detection circuit 16 is “High” in level and output signal LSS of level shift circuit 14 is “Low” in level, both output signal “A” of NAND gate ND1 and output signal “B” of NOR gate NR1 are “High” in level. As a result, P-channel MOS transistor P1 turns off and N-channel MOS transistor N1 turn on so that output terminal T1 is supplied with low voltage VGL.

Further, when both output signal SSA of power source detection circuit 16 and output signal LSS of level shift circuit 14 are “High” in level, both output signal “A” of NAND gate ND1 and output signal “B” of NOR gate NR1 are “Low” in level. As a result, P-channel MOS transistor P1 turns on and N-channel MOS transistor N1 turn off so that output terminal T1 is supplied with high voltage VGH.

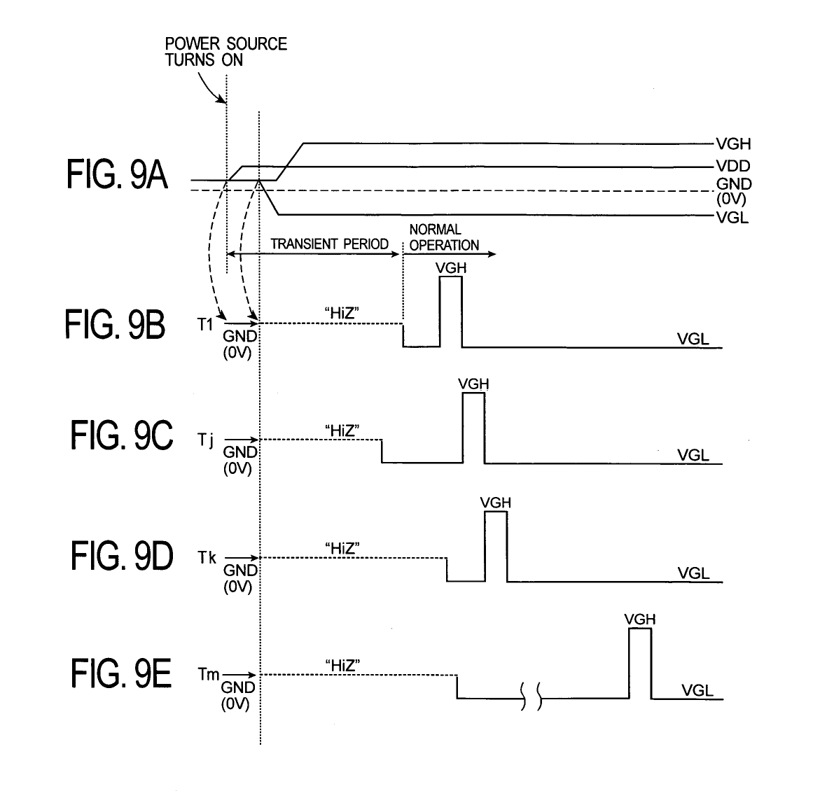

Operations of LCD device 30 are described with reference to timing charts shown in FIGS. 9A-9E. Since power source turning-on operations are substantially the same as the first embodiment, explanations thereof are omitted.

As shown in FIG. 9A, when DC-DC converter 2 turns on, output signal SSB supplied from power source detection circuit 16 to output circuit 18 makes input signal level of output terminal T1 ground potential GND (i.e., 0 V). When DC-DC converter 2 generates voltage VGL, high voltage VGH supplied to output selection circuit 20 has not risen up to a predetermined level yet. Output signal SSA of power source detection circuit 16 is “Low” in level so that all output terminals T1, T2, . . . , and Tm are in high impedance states “HiZ”. After both high and low voltages VGH and VGL reach predetermined levels, all output terminals T1, T2, . . . , and Tm are in high impedance states “HiZ” during a period of time when the level of output signal SSA of power source detection circuit 16 is “Low” in level.

Since signal level control circuit 19 of output control circuit B1 is supplied with “High” level output signal SSA of power source detection circuit 16 and “Low” level output signal LSS of level shift circuit 14, output selection circuit 20 of output control circuit B1 outputs low voltage VGL. Scanning line load 12 connected to output terminal T1 is pre-charged but an electric current supplied from DC-DC converter 2 is the only one (10 mA) supplied to one scanning line load 12. After a lapse of time “t” from the time when low voltage VGL is set, when signal level control circuit 19 of output control circuit Bj, (1<j<m), is supplied with the “High” level of output signal SSA of power source detection circuit 16 and the “High” level of output signal level shift circuit 14, output selection circuit 20 of output control circuit Bj, (1<j<m), outputs high voltage VGH. High voltage VGH is supplied to scanning line 6 through output terminal Tj, (1<j<m), so that TFT device 9 of pixel 8 turns on to display images on display panel 3. Output terminal T1 is provided with low voltage VGL again after a display period is finished.

Here, as described above, a second control device to pre-charge load 12 of scanning line 6 with voltage VGL after high impedance state “HiZ” of output terminal includes signal level control circuit 19 with which “High” level output signal SSA of power source detection circuit 16 and “Low” level output signal LSS of level shift circuit 14 are supplied.

Next, as shown in FIG. 9C-9E, substantially the same operations as output terminal T1 connected to output control circuit B1 are sequentially carried out for other output terminals Tk, . . . , Tm, (1≦k≦m, k≠j). Likewise, the same operations set forth above are carried out with respect to two scanning lines or more driven by output buffer circuits Bi and Bj, (1≦i, j≦m, i≠j), or more.

As described above, LCD device 30 in this embodiment includes power source detection circuit 16 which generates control signals in response to change in high voltage VDD for logic circuits, high voltage VGH and low voltage VGL in the event that a power source of LCD device 30 turns on and output control circuits B1, B2, B3, . . . , Bm, each of which is provided with signal level control circuit 19 and output selection circuit 20. When power source detection circuit 16 generates “Low” level output signal SSA, output terminals T1, T2, T3, . . . , Tm connected to output control circuits B1, B2, B3, . . . , Bm become high impedance states “HiZ”. When power source detection circuit 16 generates “High” level output signal SSA and level shift circuit 14 generates “Low” level output signal LSS, output control circuits B1, B2, B3, . . . , Bm output low voltage VGL to output terminals T1, T2, T3, . . . , Tm, respectively.

As a result, load 12 connected each of output terminals T1, T2, T3, . . . , Tm or a group thereof are pre-charged by electric currents supplied from DC-DC converter 2. Thus, excessive currents are prevented from flowing from DC-DC converter 2.

According to the second embodiment, such an individual pre-charge structure of LCD device 30 as described above results in a more eased load imposed on DC-DC converter 2 and the suppression of melting of wirings provided in LCD device 30 and a shutdown of circuits also provided therein. Further, it is not necessary to provide large size wiring components to avoid melting or a power source is not required for a high electric current supply capability so that the production cost of a power source is reduced.

The present invention is also applicable to driver circuits used for scanning lines of other display devices than an LCD device, such as those used for a field emission display device, an organic or inorganic electro-luminescent display device, plasma display panel, and the like. In the embodiments, the output buffer circuit includes the P-channel MOS transistor provided for the high voltages and the N-channel MOS transistor provided for the low voltages. First and second P-channel MOS transistors, however, may be used for the high and low voltages, respectively. Alternatively, first and second P-channel MOS transistors may be used for the high and low voltages, respectively. In those cases, signal levels supplied to such P-channel or N-channel MOS transistors should be appropriately set up.

In the foregoing description, certain terms have been used for brevity, clearness and understanding, but no unnecessary limitations are to be implied therefrom beyond the requirements of the prior art, because such words are used for descriptive purposes herein and are intended to be broadly construed. Moreover, the embodiments of the improved construction illustrated and described herein are by way of example, and the scope of the invention is not limited to the exact details of construction. Having now described the invention, the construction, the operation and use of embodiments thereof, and the advantageous new and useful results obtained thereby, the new and useful construction, and reasonable equivalents thereof obvious to those skilled in the art, are set forth in the appended claims.

What is claimed is:

1. A driver circuit of a display device which includes pixels to display images, data lines to supply the pixels with video signals, a shift register circuit to select the pixels, and a power source to generate a voltage, comprising:
a detection circuit to detect a starting-up portion of the voltage; and
a driver circuit provided with output terminals connected to the pixels and output buffer circuits to make the output terminals have high impedance states in response to the starting-up portion of the voltage detected by the detection circuit and subsequently supply a non-driving voltage and then a driving voltage to turn off and on the pixels selected by the shift register circuit, respectively.

2. A driver circuit according to claim 1, wherein the output buffer circuits sequentially make one of the output terminals at a time have the high impedance state in response to the starting-up portion of the voltage detected by detection circuit and sequentially supply the non-driving voltage and then the driving voltage to turn off and on one of the pixels at a time selected by the shift register circuit, respectively.

3. A driver circuit according to claim 1, wherein the output buffer circuits sequentially make two of the output terminals or more at a time have the high impedance states in response to the starting-up portion of the voltage detected by detection circuit and sequentially supply the non-driving voltage and then the driving voltage to turn off and on two of the pixels or more at a time selected by the shift register circuit to correspond to the two of the output terminals, respectively.

4. A driver circuit according to claim 1, wherein the output buffer circuits make the output terminals at random have the high impedance states in response to the starting-up portion of the voltage detected by detection circuit and supply the non-driving voltage and then the driving voltage to turn off and on the pixels selected by the shift register circuit to correspond to the output terminals, respectively.

5. A driver circuit according to claim 1, wherein each of the output buffer circuits includes an output circuit connected to one of the output terminal and first and second switching circuits that turn on to supply the non-driving voltage and then the driving voltage to the output circuit in response to the starting-up portion of the voltages detected by the detection circuit, respectively, the output circuit transmitting the non-driving voltage and then the driving voltage supplied from the first and second switching circuits to the one of the output terminals in response to an output signal of the shift register circuit.

6. A driver circuit according to claim 5, wherein the output circuit includes first and second conductive type transistors provided with gate, source and drain electrodes, the gate electrodes of the first and second conductive type transistors being supplied with an output signal of the shift resister circuit, the source electrodes of the first and second conductive type transistors being supplied with the non-driving voltage and the driving voltage from the first and second switching circuit, respectively, and the drain electrodes the first and second conductive type transistors being connected to the output terminal.

7. A driver circuit according to claim 6, wherein the output circuit further includes first and second inverters which are supplied with the output signal of the shift register and supply output signal to the gate electrodes of the first and second conductive type transistors.

8. A driver circuit according to claim 6, wherein the first and second conductive type transistors are P-channel and N-channel MOS transistors, respectively, and the first and second switching circuits are transfer gates.

9. A driver circuit according to claim 1, wherein each of the output buffer circuits includes a signal level control circuit supplied with an output signal of the shift register circuit and the starting-up portion of the voltages detected by the detection circuit; and
first and second conductive type transistors provided with gate, source and drain electrodes,
the gate electrodes of the first and second conductive type transistors being supplied with first and second output signals of the signal level control circuit, respectively,
the source electrodes of the first and second conductive type transistors being provided with the non-driving voltage and the driving voltage, respectively,
the drain electrodes of the first and second conductive type transistors being connected to the output terminal,
the first and second conductive type transistors being set to high impedance states when the starting-up portion of the voltages detected by the detection circuit is a first level,
the first conductive type transistor providing the non-driving voltage to the output terminal when the starting-up portion of the voltages detected by the detection circuit is a second level and the output signal of the shift register circuit is a first level,
the second conductive type transistor providing the driving voltage to the output terminal when the starting-up portion of the voltages detected by the detection circuit is a second level and the output signal of the shift register circuit is a second level.

10. A driver circuit according to claim 9, wherein the signal level control circuit includes an inverter, a NOR gate and a NAND gate,
the inverter inverting the starting-up portion of the voltages detected by the detection circuit,
the NOR gate being supplied with an output signal of the inverter and the output signal of the shift register circuit and supplying an output signal of the NOR gate to the first conductive type transistor,
the NAND gate being supplied with the starting-up portion of the voltages detected by the detection circuit and the output signal of the shift register circuit and supplying an output signal of the NAND gate to the second conductive type transistor.

11. A driver circuit comprising:
pixels to display images;
data lines to supply the pixels with video signals;
a shift register circuit to select the pixels;
a power source to generate voltages;
a detection circuit to detect a starting-up portion of the voltages; and
a driver circuit provided with output terminals connected to the pixels and output buffer circuits that sequentially supply a reference potential to the pixels, make the output terminals have high impedance states and supply a non-driving and a driving voltage to turn off and on the pixels selected by the shift register circuit, respectively, when the starting-up portion of the voltages is detected by the detection circuit.

12. A driver circuit according to claim 11, wherein the output buffer circuits sequentially carry out operations that make one of the output terminals at a time have the high impedance state and sequentially supply the non-driving voltage and then the driving voltage to turn off and on one of the pixels at a time, respectively, selected by the shift register circuit to correspond to the one of the output terminals.

13. A driver circuit according to claim 11, wherein the output buffer circuits sequentially carry out operations that make two of the output terminals or more at a time have the high impedance state and sequentially supply the non-driving voltage and then the driving voltage to turn off and on the two of the pixels or more at a time, respectively, selected by the shift register circuit to correspond to the two of the output terminals or more.

14. A driver circuit according to claim 11, wherein the output buffer circuits carry out operations that make the output terminals at random have the high impedance states and supply the non-driving voltage and then the driving voltage to turn off and on the pixels, respectively, selected by the shift register circuit to correspond to the output terminals at random.

15. A driver circuit according to claim 11, wherein each of the output buffer circuits includes an output circuit connected to one of the output terminals and first and second switching circuits that turn on to supply the non-driving voltage and then the driving voltage to the output circuit in response to the starting-up portion of the voltages detected by the detection circuit, respectively, the output circuit transmitting the non-driving voltage and then the driving voltage supplied from the first and second switching circuits to the one of the output terminals in response to an output signal of the shift register circuit.

16. A driver circuit according to claim 11, wherein each of the output buffer circuits includes a signal level control circuit supplied with an output signal of the shift register circuit and the starting-up portion of the voltages detected by the detection circuit, and
first and second conductive type transistors provided with gate, source and drain electrodes,
the gate electrodes of the first and second conductive type transistors being supplied with first and second output signals of the signal level control circuit, respectively,
the source electrodes of the first and second conductive type transistors being provided with the non-driving voltage and the driving voltage, respectively,
the drain electrodes of the first and second conductive type transistors being connected to the output terminal,
the first and second conductive type transistors being set to high impedance states when the starting-up portion of the voltages detected by the detection circuit is a first level,
the first conductive type transistor providing the non-driving voltage to the output terminal when the starting-up portion of the voltages detected by the detection circuit is a second level and the output signal of the shift register circuit is a first level,
the second conductive type transistor providing the driving voltage to the output terminal when the starting-up portion of the voltages detected by the detection circuit is a second level and the output signal of the shift register circuit is a second level.

17. A method of driving a display device which includes pixels to display images, data lines to supply the pixels with video signals, a shift register circuit to select the pixels, and a power source to generate a voltage, a detection circuit to detect a starting-up portion of the voltage, and a driver circuit provided with output terminals connected to the pixels and output buffer circuits, comprising:
making the output terminals have high impedance states in response to the starting-up portion of the voltage detected by the detection circuit; and
subsequently supplying a non-driving voltage and then a driving voltage to turn off and on the pixels selected by the shift register circuit, respectively.

18. A method of driving a display device according to claim 17, wherein said making the output terminals have the high impedance state is carried out for one of the output terminals at a time by the output buffer circuits in response to the starting-up portion of the voltage detected by detection circuit and the supplying of the non-driving voltage and then the driving voltage to turn off and on is carried out for one of the pixels at a time selected by the shift register circuit, respectively.

19. A driver circuit according to claim 17, wherein said making the output terminals have the high impedance states is carried out for two of the output terminals or more at a time in response to the starting-up portion of the voltage detected by detection circuit and the supplying of the non-driving voltage and then the driving voltage to turn off and on is carried out for two of the pixels or more at a time selected by the shift register circuit to correspond to the two of the output terminals, respectively.

20. A driver circuit according to claim 1, wherein said making the output terminals have the high impedance states is carried out at random in response to the starting-up portion of the voltage detected by detection circuit and said supplying of the non-driving voltage and then the driving voltage to turn off and on is carried out for random pixels selected by the shift register circuit to correspond to the output terminals, respectively.
